(19) United States
(12) Patent Application Publication
(10) Pub. No.: US 2010/0164433 A1
(43) Pub. Date: Jul. 1, 2010

(54) Wireless Battery Charging Systems, Battery Systems and Charging Apparatus

(75) Inventors: Anand Janefalkar, Arlington Heights, IL (US); Mark Carlson, Round Lake, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Libertyville, IL (US)

(21) Appl. No.: 12/345,951

(22) Filed: Dec. 30, 2008

(51) Int. Cl. H02J 7/02; H02N 2/18

(52) U.S. Cl. 320/115; 310/339

(57) ABSTRACT

Disclosed is a battery charging system, a battery system, a charging apparatus, wherein the charging apparatus includes an ultrasonic wave generator configured to be in intimate proximity to an ultrasonic wave receiving device including a piezoelectric component. The ultrasonic wave receiving device includes a piezoelectric component of a resonant frequency substantially matching the frequency of the transmitted ultrasonic waves from the ultrasonic wave generator. A gel-based surface of the charging apparatus is configured to be in intimate proximity with both the piezoelectric component and the ultrasonic wave generator. The piezoelectric component is coupled to a battery by a circuit, the piezoelectric component configured to receive ultrasonic wave vibrations of the ultrasonic waves, the ultrasonic wave receiving device further including a circuit configured to convert the mechanical vibrations to electrical energy in accordance with an inverse piezoelectric effect. The battery is configured to receive and store the energy.

### FIELD

Disclosed is a battery charging system, a battery system, a charging apparatus, wherein the charging apparatus includes an ultrasonic wave generator configured to be in intimate proximity to an ultrasonic wave receiving device including a piezoelectric component.

### BACKGROUND

To charge the battery of an electronic device, a wired battery charger having a particular transformer is typically used. A user must plug the battery charger into an appropriate voltage power outlet and into the device to charge the device's battery. Oftentimes, the particular transformer is specific to a particular electronic device and not interchangeable for use with other devices.

In various circumstances, the use of a wireless charge pad apparatus for charging of a battery of an electronic device can provide convenience to a user. The same technology utilized to charge an electric toothbrush, inductive charging, has been use in wireless charge pad apparatus technology. However, the coupling is highly dependent upon two charging coils being in extremely good alignment. Docking stations for electronic devices in an inductive charge pad apparatus can provide the alignment necessary for good coupling. However, as with a wired charger, a docking station may be specific to a particular electronic device and not interchangeable for use with other devices.

### BRIEF DESCRIPTION OF THE DRAWINGS

FIG. 1 is an embodiment of system of an ultrasonic wave receiving device and a charging apparatus;

FIG. 2 depicts an embodiment of the system of an ultrasonic wave receiving device that can be in initimate proximity with a charging apparatus; and

FIG. 3 depicts another embodiment of an ultrasonic wave receiving device.

### DETAILED DESCRIPTION

It would be beneficial if a charge pad apparatus provided more interchangability and convenience. Moreover, it would be beneficial were a wireless charge pad apparatus capable of accommodating a plurality of different kinds of devices, so that the inconvenience of plugging each of a plurality of devices to specific wired chargers could be avoided. Moreover, it would be beneficial were a charging system to use ultrasonic vibrations as opposed to electromagnetism of inductive charging since ultrasonic vibrations may be less harmful since they do not cause tissue heating below a threshold for wireless charging.

Disclosed is a battery charging system, a battery system, a charging apparatus, wherein the charging apparatus includes an ultrasonic wave generator configured to be in intimate proximity to an ultrasonic wave receiving device including a piezoelectric component. A piezoelectric material generates an electric charge when mechanically deformed, in this case by vibrations of an ultrasonic wave generator. Conversely, when an external electric field is applied to piezoelectric materials they mechanically deform.

The ultrasonic wave receiving device includes a piezoelectric component of a resonant frequency substantially matching the frequency of the transmitted ultrasonic waves from the ultrasonic wave generator. The piezoelectric component is coupled to a battery by a circuit, the piezoelectric component configured to receive ultrasonic wave vibrations of the ultrasonic waves, the ultrasonic wave receiving device further including a circuit configured to convert the mechanical vibrations to electrical energy in accordance with an inverse piezoelectric effect. The battery is configured to receive and store the energy.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

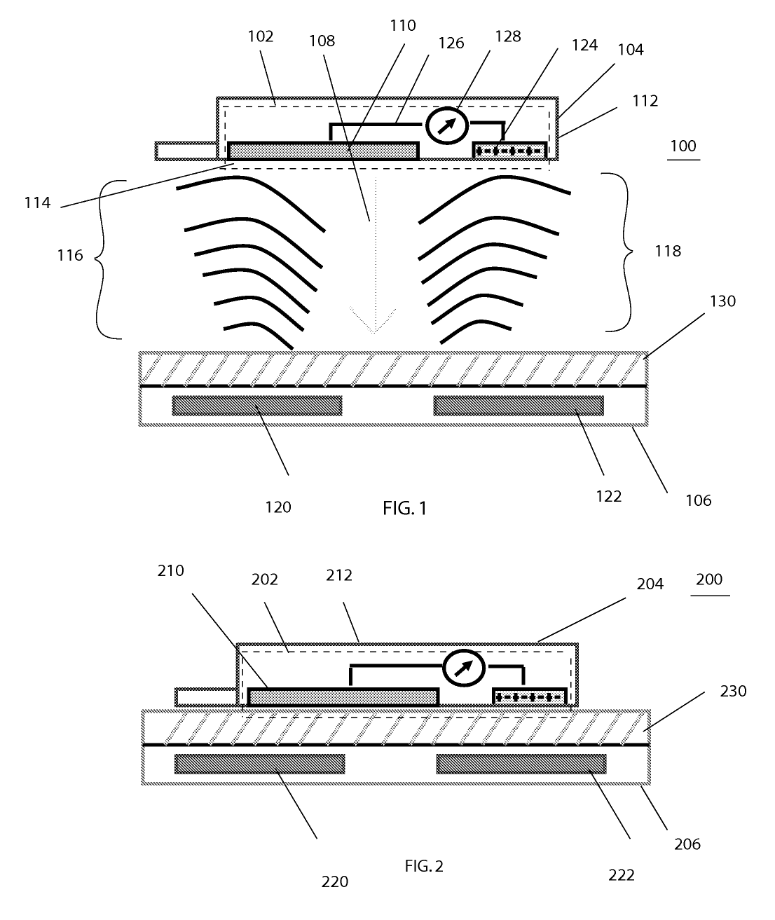

FIG. 1 is an embodiment of system 100 of an ultrasonic wave receiving device 102 within dotted lines that can be supported by a housing of an electronic device 104. Also depicted is a charging apparatus 106. The ultrasonic wave receiving device 102 is depicted on a trajectory 108 to be in intimate proximity with the charging apparatus 106. It is understood that the electronic device 104 can be any type of electronic device, including for example a mobile communication device. One or more piezoelectric components 110 of the ultrasonic wave receiving device 102 are preferably supported by the housing 112 of the electronic device 104 on a side 114 of the electronic device 104 that can be in intimate proximity with the charging apparatus 106, but of course can be in any suitable location.

The ultrasonic wave receiving device 102 includes a piezoelectric component 110 of a resonant frequency substantially matching the frequency of the transmitted ultrasonic waves 116 and 118 from one or more ultrasonic wave generators 120 and 122. The embodiment of depicted charging apparatus 106 includes two ultrasonic wave generators 120 and 122 which generate waves 116 and 118 having the same or different resonant frequencies. A charging apparatus 106 may include generally defined locations for focused ultrasonic wave generation having the same or different resonant frequencies. In this way, a plurality of ultrasonic wave receiving devices 102 having a plurality of piezoelectric components 110 with different properties may be charged on the same charging apparatus 106.

The piezoelectric component 110 is coupled to a battery 124 by a circuit 126. The piezoelectric component, for example, can be a ceramic device, tuned to receive frequencies or harmonics of the waves 116 and/or 118. In addition or conversely, ultrasonic transducers 120 and 122 may be configured to transmit ultrasonic waves 116 and/or 118 at frequencies or harmonics that match the piezoelectric component 110 or its multiples. The ultrasonic wave receiving device 102 further includes a circuit component such as a current generator 128 configured to convert mechanical vibrations to electrical energy in accordance with an inverse piezoelectric effect. That is the current generator 128 can convert the vibrations to energy including at least one of a charging voltage and a charging current. The battery 124 is configured to receive and store the energy and of course can be located anywhere.

Ultrasonic transducers 120 and 122 may be proximal to a layer 130 configured to transmit therethrough wave vibrations of the ultrasonic waves 116 and/or 118 from the ultrasonic wave generators 120 and/or 122. The layer 130 can be any medium, for example, a gel-based surface for border-efficiency between the piezoelectric component 110 in intimate proximity with the charging apparatus 106 as well as providing enhanced coupling with the ultrasonic wave receiving device 102. Water-based gel may provide a minimum loss of ultrasonic energy when waves travel through the water-like medium. The layer 130 can therefore provide focusing, beaming and/or alignment, optimizing the wave energy transmitted from the ultrasonic transducers 120 and/or 122 to the piezoelectric component 110.

FIG. 2 depicts an embodiment of the system 200 of an ultrasonic wave receiving device 202 that can be in initimate proximity with a charging apparatus 206. In particular, the piezoelectric component 210 is depicted in intimate proximity with the charging apparatus 106. As mentioned the layer 230 can provide border-efficiency between the piezoelectric component 310 in intimate proximity with the charging apparatus 206 as well as providing enhanced coupling with the piezoelectric component 210 of the ultrasonic wave receiving device 102.

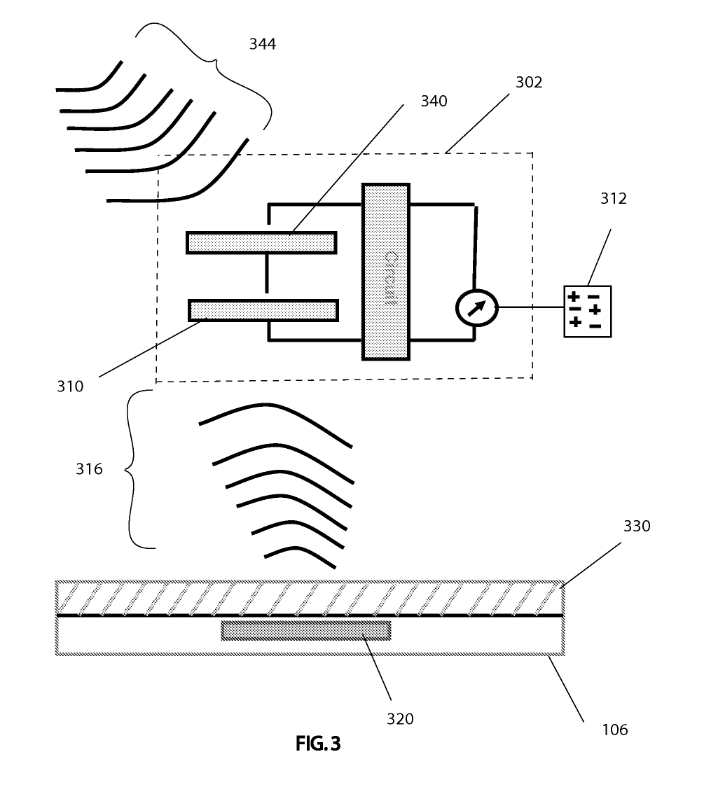

FIG. 3 depicts another embodiment of an ultrasonic wave receiving device 302 within dotted lines. As depicted in FIGS. 1 and 2, a piezoelectric component 310 can receive vibrations 316 from a charging apparatus 306 including one or more ultrasonic wave generators 320 transmitted therethrough a gel-based surface 330 configured to be in intimate proximity with both the piezoelectric component 310 and the ultrasonic wave generator 320. An embodiment of a second piezoelectric component 240 is depicted as part of the ultrasonic wave receiving device 302 that may receive vibrations from the one or more ultrasonic wave generators 320 and/or another source of vibrations. For example, battery charging system 302 can include a component 340, such as a piezoelectric component, having a resonance frequency configured to receive ultrasonic or sonic frequencies of environmental vibrations 344. It is understood that environmental vibrations may be generated by a number of ambient sources. Component 340 can resonate at vocal frequencies can be configured to receive sonic wave vibrations 344 at the mouthpiece of a communication device as well. The mechanical energy received by two or more piezoelectric components 310 and 340 can be converted to electric energy and stored in a battery 312.

The disclosed charge pad apparatus can provide interchangability and convenience. Moreover, beneficially, the disclosed a wireless charge pad apparatus is capable of accommodating a plurality of different kinds of devices, so that the inconvenience of plugging each of a plurality of devices to specific wired chargers could be avoided. Also, beneficially, the disclosed charging system can utilize ultrasonic vibrations as opposed to electromagnetism of inductive charging that are less harmful since they do not cause tissue heating below a particular threshold for wireless charging.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A battery charging system, comprising:
a charging apparatus including an ultrasonic wave generator configured to be in intimate proximity to a piezoelectric component of an ultrasonic wave receiving device; and
the ultrasonic wave receiving device including the piezoelectric component of a resonant frequency substantially matching the frequency of the transmitted ultrasonic waves from the ultrasonic wave generator; the piezoelectric component coupled to a battery, the piezoelectric component configured to receive ultrasonic wave vibrations of the ultrasonic waves, the ultrasonic wave receiving device further including a circuit configured to convert the mechanical vibrations to electrical energy in accordance with an inverse piezoelectric effect, wherein the battery is configured to receive and store the energy.

2. The charging apparatus of claim 1, comprising:
a gel-based surface configured to be in intimate proximity with both the piezoelectric component and the ultrasonic wave generator.

3. The charging apparatus of claim 1, comprising:
an alignment system configured to align the ultrasonic wave generator, the gel-based surface, and the piezoelectric component.

4. The battery charging system of claim 1 wherein to convert the vibrations to energy includes converting the vibrations to at least one of a charging voltage and a charging current.

5. The battery charging system of claim 1 wherein the piezoelectric component and the battery are housed in a housing of an electronic device.

6. The battery charging system of claim 1 wherein the resonant frequency of the piezoelectric component is multiples of the resonant frequency of the ultrasonic waves.

7. The battery charging system of claim 1 wherein piezoelectric component is configured to receive frequencies of environmental vibrations.

8. The battery charging system of claim 1 wherein the piezoelectric component is configured to receive vocal frequencies.

9. The battery charging system of claim 1 the ultrasonic wave receiving device includes a plurality of piezoelectric components wherein a first piezoelectric component of the plurality of piezoelectric components resonates as at first resonant frequency and a second piezoelectric commonest resonates at a second resonant frequency.

10. A battery system, comprising:
an ultrasonic wave receiving device including a piezoelectric component having a resonance frequency is configured to be coupled to a battery, the piezoelectric component configured to receive ultrasonic wave vibrations, the battery system including a circuit configured to convert the vibrations to energy in accordance with an inverse piezoelectric effect, wherein the battery is configured to receive and store the energy, and wherein the ultrasonic receiving device is configured to be in intimate proximity with an ultrasonic generating apparatus.

11. The battery charging system of claim 10 wherein to convert the vibrations to energy includes converting the vibrations to at least one a charging voltage and current.

12. The ultrasonic generating apparatus of claim 10, comprising:
a gel-based surface configured to be in intimate proximity with both the piezoelectric component and the ultrasonic wave generator.

13. The battery charging system of claim 10 wherein the piezoelectric component and the battery are housed in a housing of an electronic device.

14. The battery charging system of claim 10 wherein the resonance frequency of the piezoelectric component is configured to receive frequencies of environmental vibrations.

15. The battery charging system of claim 10 wherein the piezoelectric component is configured to receive vocal frequencies.

16. The battery charging system of claim 10 the ultrasonic wave receiving device includes a plurality of piezoelectric components wherein a first piezoelectric component of the plurality of piezoelectric components resonates as at first resonant frequency and a second piezoelectric commonest resonates at a second resonant frequency.

17. A charging apparatus, comprising:
an ultrasonic wave generator configured to generate ultrasonic waves having a particular resonance frequency; and
a gel-based surface configured to transmit ultrasonic waves therethrough wherein the charging apparatus is configured to be in intimate proximity with an ultrasonic wave receiving device.

18. The charging apparatus of claim 17, wherein the particular resonance frequency of the ultrasonic waves is matched to a resonance frequency of a type of piezoelectric component.

19. The charging apparatus of claim 17, comprising:
an alignment system configured to align the ultrasonic wave generator, the gel-based surface with an ultrasonic wave receiving device.
